(19) United States
(12) Patent Application Publication
(10) Pub. No.: US 2015/0143197 A1
(43) Pub. Date: May 21, 2015

(54) Codes for Enhancing the Repeated Use of Flash Memory

(71) Applicant: Shmuel T. KLEIN, Rehovot (IL)

(72) Inventor: Shmuel T. KLEIN, Rehovot (IL)

(21) Appl. No.: 14/318,648

(22) Filed: Jun. 29, 2014

Related U.S. Application Data
(60) Provisional application No. 61/844,443, filed on Jul. 10, 2013.

(51) Int. Cl. G06F 11/10

(52) U.S. Cl. CPC G06F 11/1028; G06F 11/1068
USPC 714/767

(57) ABSTRACT

A basic property of flash memory is that: a 0-bit can be changed into a 1-bit, but not vice-versa, which severely limits the possibilities of reusing storage space with new data. A family of new coding methods is presented that enables double use of the memory, effectively expanding the combined amount of stored data. This can then be used as a compression booster, adding an additional layer to, and improving the compression of some rewriting methods that are not context sensitive.

### 1. TECHNOLOGICAL FIELD

This invention relates to the storage of data in computer readable form, and more specifically to the efficient storage of such data on memory devices known as flash memory.

### 2. PRIOR ART

References considered to be relevant as background to the presently disclosed subject matter are listed below:

[1] Apostolico A., Fraenkel A. S., Robust transmission of unbounded strings using Fibonacci representations, IEEE Trans. Inform. Theory 33 (1987) 238-245.

[2] Assar M. Nemazie S., Estakhri P., Flash memory mass storage architecture, U.S. Pat. No. 5,388,083, issued Feb. 7, 1995.

[3] Chen C-H., Chen C-T., huang W-T., The real-time compression layer for flash memory in mobile multimedia devices, Mobile Networks and Applications 13(6) (2008) 547 554.

[4] Fiat A., Shamir A., Generalized ‘write-once’ memories. IEEE Transactions on Information Theory IT-30(3) (1984)-470-479.

[5] Fraenkel A. S., Systems of numeration, Amer. Math. Monthly 92 (1985) 105-114.

[6] Fraenkel A. S., Klein S. T., Robust Universal Complete Codas for Transmission and Compression, Discrete Applied Mathematics 64 (1996) 31-55.

[7] Gal E., Toledo S., Algorithms and data structures for flash memories, ACM Comput. Surv. 37(2) (2005) 138 163.

[8] Huang H-L., Huang C-F., Chou M-H., Cho S-K., Uniform coding system for a flash memory, U.S. Pat. No. 8.074,013, issued Dec. 6, 2011.

[9] Immink K. A., NijboerJ. G., Ogawa H., Odaka K., Method of coding binary data, U.S. Pat. No. 4,501,000, issued Feb. 19, 1985.

[10] Jiang A., Bohossian V., Bruck J., Rewriting codes for joint information storage in flash memories, IEEE Transactions on Information Theory IT-56(10) (20.12) 5300-5313.

[11] Klein S. T., Should one always use repeated squaring for modular exponentiation?, Information Processing Letters 106(6) (2008) 232-237.

[12] Klein S. T., Combinatorial Representation of Generalized Fibonacci Numbers, The Fibonacci Quarterly 29 (1991) 124-131.

[13] Klein S. T., Kopel Ben-Nissan M., On the Usefulness of Fibonacci Compression Codes, The Computer Journal 53 (2010) 701 716.

[14] Klein S. T., Shapira D., Compressed Matching in Dictionaries. Algorithms 4(1) (2011) 61-74.

[15] Kurkoski B. M., Rewriting codes for flash memories based upon lattices, and an example using the ES lattice, IEEE Globecom Workshop on Applications of Communication Theory to Emerging Memory Technologies (2010) 1861-1865.

[16] PetersenR. M., Schuette F. M., On-device data compression to increase speed and capacity of flash memory-based mass storage devices U.S. Pat. No. 7,433,994, issued Oct. 7, 2008.

[17] RivestR. L., Shamir A., How to reuse a “Write-once” memory, Information and Control 55(1-3) (1982) 1-19.

[18] Shpilka A., New constructions of WOM codes using the Wozencraft ensemble, IEEE Transactions on Information Theory IT-59(7) (2013) 4520-4529.

[19] Weingarten H., Levy S., Bar I., Apparatus for coding at a plurality of rates in multi-level flash memory systems, and methods useful in conjunction therewith, U.S. Pat. No. 8,327,246, issued Dec. 4, 2012.

[20] Yaacobi E., Kayser S., Siegel P. H., Vardy A., Wolf J. K., Codes for Write-Once Memories, IEEE Trans on Information Theory 58(9) (2012) 5985-5999.

[21] Yoon S., High density flash memory architecture with columnar substrate coding, U.S. Pat. No. 6,864,530, issued Mar. 8, 2005.

[22] Zeckendorf E., Representation des nombres naturels par une somme des nombres de Fibonacci ou de nombres de Lucas, Bull. Soc. Roy. Set. Liège 41 (1972) 179 182.

### 3. BACKGROUND

The advent of flash memory [2, 7] in the early 1990s had a major impact on industries depending on the availability of cheap, massive storage space. Flash memory is now omnipresent in our personal computers, mobile phones, digital cameras, and many more devices. There are, however, several features that are significantly different for flash memory, when compared to previously know) storage media.

Without going into the technical details leading to these changes, to appreciate the present invention, it suffices to know that, contrarily to conventional storage, writing a 0-bit or a 1-bit, on flash are not considered to be symmetrical tasks. If a block contains only 0s (consider it as a freshly erased block), individual bits can be changed to 1. However, once a bit is set to 1, it can be changed back, to value 0 only by erasing entire blocks (of size 0.5 MB or more). Therefore, while one can randomly access and read any data in flash memory, overwriting or erasing it cannot be performed in random access, only blockwise.

The problem of compressing data in the context of flash memory has been addressed in the literature and in many patents, see [3, 10, 21, 19, 8] to cite just a few, but they generally refer to well known compression techniques, that can be applied for any storage device. The current invention focuses on changing the coding method used on the device and obtaining thereby a compression gain, as also done in [17, 20].

Consider then the problem of reusing a piece of flash memory, after a block of r bits has already been used to encode some data in what we shall call a first round of encoding. Now some new data is given to be encoded in a second round, and the challenge is to reuse the same r bits, or a subset thereof, without incurring the expensive overhead of erasing the entire block before rewriting.

There might, of course, be a possibility of recoding data using only changes from 0-bits to 1-bits, but not vice versa. For example, suppose one is given a data block containing 00110101, it could be changed to 10111101 or 00111111, but not to 00100100. The problem here is that since every bit encoded in the first round can a priori contain either 0 or 1, only certain bit patterns can be encoded in the second round, and even if they can be adapted to the new data, there need to be a way of knowing which bits have been modified in the passage from the first to the second round.

Actually, the problem of devising such special codes has been treated long before flash memory became popular, under the name of Write-Once Memory (WOM). Rivest and Shamir (RS) suggested a simple way to use 3 bits of memory to encode two rounds of the four possible values of 2 bits [17]. This work has been extended over the years, see, e.g., [4, 10, 15, 17, 18, 20], and the corresponding codes are called rewriting codes.

As a baseline against which the compression efficiency of the new method can be compared, we use the compression ratio defined as the number of information bits di-vided by the number of storage bits. The number of information bits is in fact the information content, of the data, whereas the number of storage bits depends on the way the data, is encoded. For example, consider a 3-digit decimal number, with each digit being encoded in a 4-bit binary encoded decimal, that is, the digits 0, 1, . . . , 9 are encoded as 0000, 0001, . . . , 1001, respectively. The information content of the three digits is −[log₂ 1000]=10 and the number of storage bits is 12, which yields the ratio 10/12=0.833. For a standard binary encoding, information and storage bits are equivalent, giving a baseline of 1. For rewriting codes, we use the combined number of information bits of all writing rounds, thus the above mentioned RS-code yields a ratio of

$$\frac{4}{3} = 1.333 .$$

The theoretical best possible ratio is log 3=1.585 and the best achieved ratio so far is 1.49, see [18].

For the RS-code, every bit-triplet is coded individually, independently of the preceding ones. The code is thus not context sensitive, and this is true also for many of its extensions. One of the innovations of the present invention is to exploit context sensitivity by using a special encoding in the first round that might be more wasteful than the standard encoding, but has the advantage of allowing the unambiguous reuse of a part of the data bits in the second round, such that the overall number of bits used in both rounds together is increased. This effectively increases the storage capacity of the flash memory between erasing cycles. Taken as a stand-alone rewriting technique, the compression ratio of the basic scheme suggested in this invention is shown to vary between 1.028 in the worst case to at most 1.194, with an average of 1.162. This is less than the performance of the RS-code.

The new method has, however, other advantages. It can be generalized to yield various partitions between the first and the second, rounds, while the RS-code is restricted to use the same number of bits in both rounds. More importantly, the suggested codes can be used as compression boosters, transforming any context insensitive k-rewriting system (with k≧2 writing rounds) into a (k+1)-rewriting system, which may lead to an improved overall compression ratio. One of the variants transforms the RS-code into a 3-rewriting code with compression ratio 1.456, a 9.2% increase of storage space over using RS as a stand-alone encoding. Note that these numbers, as well as those above, are analytically derived, and not experimental estimates.

### 4. BRIEF DESCRIPTION OF THE DRAWINGS

FIG. 1 is a small Encoding example.

FIG. 2 shows a decoding automaton for data in the second round.

FIG. 3 shows a decoding automaton for data in the second round with A⁽³⁾.

FIG. 4. is a graphical representation of compression gains.

FIG. 5 is another view of a graphical representation of compression gains.

FIG. 6 is an encoding example with A⁽³⁾.

### 5. DETAILED DESCRIPTION OF EMBODIMENTS

### 5.1 Basic Encoding Method

Consider an unbounded stream of data bits to be stored. It does not matter what these input bits represent and various interpretations might be possible. For example, the binary string 010011100101000101111000 could represent the ascii encoding of the character string NQx, as well as the standard binary encoding of the integer 5,132,064. By working-directly at the level of data bits, the following method is most, general and could be applied to any kind of input data.

For technical reasons, it is convenient to break the input stream into successive blocks of n bits, for some constant n. This may help limiting the propagation of errors and setting an upper bound to the numbers that, are manipulated. In any case, this does not limit the scope of the method, as the processed blocks can be concatenated to restore the original input. To continue the above example, if n=8, the input blocks are 01001110, 01010001 and 01111000 the first of which represents the character N or the number 78. The description below concentrates on the encoding of a single block of length n.

A block of n bits can be used to store numbers between 0 and 2ⁿ−1 in what is commonly called the standard binary representation, based, on a sum of differ cut powers of 2. Any number x in this range can be uniquely represented by the string bₙ₋₁, bₙ₋₂ . . . b₁b₀, with bᵢε{0,1}, such that x=Σᵢ₌₀ⁿ⁻¹bᵢ2ⁱ. But this is not the only possibility. Actually, there are infinitely many binary representations for a given integer, each based on a different numeration system [5], The numeration system used for the standard representation is the sequence of powers of 2: {1, 2, 4, 8, . . . }. Another popular and useful numeration system in this context is based on the Fibonacci sequence: {1, 2, 3, 5, 8, 13, . . . }.

Fibonacci numbers are defined by the following recurrence relation:

Fᵢ=Fᵢ₋₁+Fᵢ₋₂for i≧1,

and the boundary conditions

F₀=1

and

F₋₁=0.

The number Fᵢ, for i≧1, can be approximated by φ^{[+]}/\sqrt{5}, rounded to the nearest integer, where

$$φ = \frac{1 + \sqrt{5}}{2}$$

is the golden ratio.

Any integer x can be decomposed into a sum of distinct Fibonacci numbers; it can therefore be represented by a binary string c_{γ} c_{γ-1} . . . c₂c₁ of length r, called its Fibonacci or Zeckendorf representation [22], such that x=Σᵢ₌₁^{x}cᵢFᵢ. This can be seen from the following procedure producing such a representation: given the integer x, find the largest Fibonacci number Fᵣ smaller or equal to x; then continue recursively with x−Fᵣ. For example, 49=34+13+2=F₈+F₆+F₂, so its binary Fibonacci representation would be 10100010. Moreover, the use of the largest possible Fibonacci number in each iteration implies the uniqueness of this representation. Note that as a result of this encoding procedure, there are never consecutive Fibonacci numbers in any of these sums, implying that in the corresponding binary representation, there are no adjacent 1s.

This property of the appearance of a 1-bit implying that the following bit must be a zero has been exploited in several useful applications: robustness to errors [1], the design of Fibonacci codes [6], fast decoding and compressed search [13], compressed matching in dictionaries [14], faster modular exponentiation [11], etc. The present invention is yet another application of this idea.

The repeated encoding will be performed in three steps:

1. Encoding the data of the first round;

2. Preparing the data block for a possible second encoding:

3. Encoding the (new) data of the second round, overwriting the previous data.

In the first step, the n bits of the block are transformed into a block of size r by recoding the integer represented in the input, block into its Fibonacci representation. The resulting block will be longer, since more bits are needed, but also sparser, because of the property prohibiting adjacent 1s. To get an estimate of the increase in the number of bits, note that the largest number that can be represented is y=2ⁿ−1. The largest Fibonacci number Fᵣ≈φ^{r+i}/\sqrt{5} needed to represent y is r=[log_{φ}(\sqrt{5}y)−1]=[1.44n−0.67]. The storage penalty incurred by passing from the standard to the Fibonacci representation is thus at most 44%, for any block size n.

The second step is supposed to be performed after the data written in the first round has finished its life cycle and is not needed any more, but instead of overwriting it by erasing first the entire block, we wish to be able to reuse the block subject to the update constraints of flash memory. The step is optional and not needed for the correctness of the procedure, but it may increase the number of data bits that can be stored in the second round. In the second step, a maximal number 1-bits is added without violating the non-adjacency property of the Fibonacci encoding. This means that short, runs of zeros limited by 1-bis, like 101 and 1001, are not touched, but the longer ones, like 100001 or 1000001, are changed to 101001 and 1010101, where the added bits are bold faced. In general, in a run of zeros of odd length 2i+1, every second zero is turned on, and this is true also for a run of zeros of even length 2i, except that for the even length the last bit is left, as zero, since it is followed by a 1. A similar strategy is used for a run of leading zeros in the block: a run of length 1 is left untouched, but longer runs, like 001, 0001 or 00001, are changed to 101, 1001 and 10101, respectively. As a result of this filling strategy, the data block still does not have any adjacent 1s, but the lengths of the 1-limited zero-runs is now either 1 or 2, and the length of the leading run is either 0 or 1.

In the third step, new data is encoded in the bits immediately to the right, of every 1-bit. Since it is known that these positions contained only zeros at the end of step 2, they can be used at this stage to record new data, and their location can be identified. The data block at the end of the third step thus contains bits of three kinds: separator bits (S), data bits (D) and extension bits (E). The first bit of the blocks is either an S-bit, if it is 1, or an E-bit, if it is 0 (which can only occur if the leading zero-run was of length 1).
S-bits have value 1 and are followed by D-bits;
D-bits have value 0 or 1 and are followed by an S-bit (1) or by an E-bit (0);
E-bits have value 0 and are followed by S-bits.

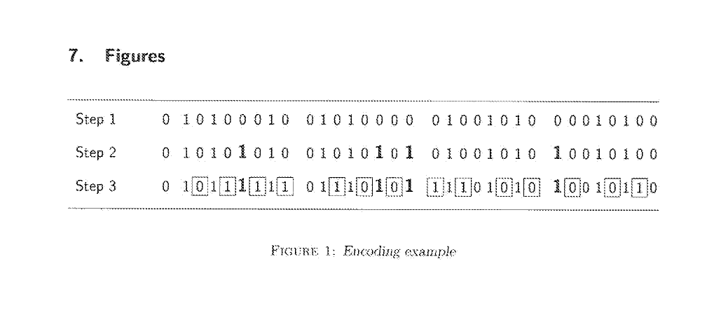

FIG. 1 continues the running example, showing the data block at the end of each of the steps. The strings are partitioned into blocks of 8 bits just for visual convenience. The input is the character string NQx, and the 24 bit numerical value 5,132,664 of its ASCII encoding (with leading zeros), is given in Fibonacci encoded form with [1.44×24−0.67]=33 bits in the first line. The second line displays the block at the end of step 2, after having added some 1-bits which are bold-faced. The data bits that can be used in the next step are those immediately to the right of the 1-bits and are currently all zero. In this example, there are 14 such bits. For the last step, suppose the new data to be stored is the number 7777, whose standard 14-bit binary representation is 0111001100001. These bits are interspersed into the data bits of the block, resulting in the string appearing in the third line, in which these data bits are boxed. In this example, the combined number of information bits is 24 for the string NQx, plus 14 for the number 7777, that is 38 bits, but using only 33 bits of storage, yielding a compression ratio of 1.152. Note also that all the changes from one step to another are consistent with the flash memory constraints, namely that only changes from 0 to 1 are allowed, but, not from 1 to 0.

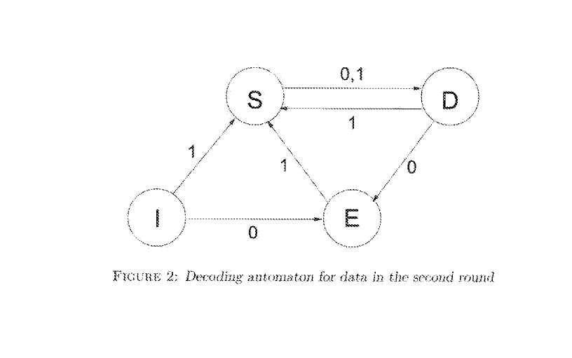

Decoding at the end of the first step is according to Fibonacci codes, as in [13], and decoding of the data of the second round at the end of the third step can be done using the decoding automaton appearing in FIG. 2. An initial state 1 is used to decide whether to start in state S if the first bit is a 1, or in state E if it is a zero. The states S, D and E are entered after having read an S-bit, D-bit and E-bit, respectively. Only bits leading to state D are considered to carry information. There is no edge labeled 0 emanating from state E, because E-bits are always followed by 1s.

### 5.2 Space Analysis

Since at the end of the second step, no run of zeros can be longer than 2, the worst case scenario is when every third bit is a separator. Any block is then of the form SDESDE . . . , and one third of the bits are data-bits. The number of data bits in the third step is thus 1.44 n/3=0.48 n, which together with the n bits encoded in the first step, yield 1.48 n, 2.76% more than the 1.44 n storage bits used. Thus even in the worst case, there is a gain albeit a small one.

The maximal possible benefit, will be in the case when there are no E-bite at all, that is the block is of the form SDSDSD . . . . In this case, half of the bits axe D-bits, and the compression ratio will be

$$\frac{\frac{1.44 n}{2} + n}{1.44 n} = 1.194 .$$

The constraint of the Fibonacci encoding implies that the probabilities of occurrence of 0s and 1s are not the same, as would be the case in the standard binary encoding, when all possible inputs are supposed to be equi-probable. Under such an assumption, the probability of a 1-bit is shown in [11] to

$$p = \frac{1}{2} - \frac{1}{2 \sqrt{5}} = 0.2764$$

when the block size n tends to infinity. From this, one can derive that the expected distance between consecutive S-bits, which is the expected length of a zero-run including the terminating 1-bit in the data block at the end of the second step, is

$$E = 2 + \frac{\sqrt{5} - 1}{2} ln ( \frac{5}{4} ) = 2.1379 .$$

This yields an average compression ratio of

$$\frac{\frac{1.44 n}{2.14} + n}{1.44 n} = 1.162 . \qquad ( 1 )$$

Summarizing, the new code effectively expands the storage capacity of flash memory by 3 to 19%, and at the average 16%.

### 5.3 Alternative Encoding

The basic idea leading to the possibility above of multiple encoding rounds is the use of a code in which certain bits are guaranteed to be 0. This is true for the Fibonacci, coding, in which every 1-bit is followed by a 0-bit, which can be extended to a code in which every 1-bit is followed by at least m 0-bits, for m>1. Such a code for m=2 has been designed tor the encoding of data on CD-ROMs [9] and is known as Eight-to-Fourteen-Modulation (EFM); every byte of 8 bits is mapped to a bit-string of length 14 in which there are at least two zeros between any two 1s.

These properties are obtained by representing numbers according to the basis elements of numeration systems which are extensions of the Fibonacci sequence. To get sparser strings, use the numeration systems based on the following recurrences, see [12]:

Aₖ^{(m)}=Aₖ₋₁^{(m)}+Aₖ₋ₘ^{(m)} for k>m+1,

and the boundary conditions

Aₖ^{(m)}=k−1 for 1<k≦m+1.

In particular. Aₖ⁽²⁾=Fₖ₋₁⁽²⁾=Fₖ₋₁ are the standard Fibonacci numbers. The first few elements of the sequences A^{(m)} ≡{1=A₂^{(m)},A₃^{(m)},A₄^{(m)} . . . } for 2≦m≦8 are listed in the right part of Table 1 below.

A closed form expression of the elements of the sequence A^{(m)} can be obtained by considering the characteristic polynomial x^{m}−x^{m}−1=0, and finding its m roots φ_{m,1}, φ_{m,2}, . . . , φ_{m,m}. The element Aₖ^{(m)} is then a linear combination of the k-th power of these roots. For these particular polynomials, when m>2, there is only one root, say φ_{m,1}≡φₘ, which is real and is larger than 1, all the other roots are complex numbers a+ib with b≈0 and with norm strictly smaller than 1. For m=2, the second root

$$\frac{1 - \sqrt{5}}{2} = - 0.6180$$

is also real, but its absolute value is <1. It follows that with increasing k, all the terms φ_{m,j}^{k}, 1<j≦m, quickly vanish, so that the elements Aₖ^{(m)} can be accurately approximated by powers of the dominant, root φₘ alone, with appropriate coefficients, Aₖ^{(m)}≈aₘφₘ^{k-1}. The constants aₘ and φ^{m} are listed in Table 1.

For a given m, any integer x can be decomposed into a sum of distinct elements of the sequence A^{(m)}; it can therefore be uniquely represented by a binary string cᵣcᵣ₋₁ . . . c₃c₂ of length r−1, such that x=Σᵢ₌₂^{r} c₁Aᵢ^{(m)}, using the recursive encoding method presented in the previous section, based on finding in each iteration the largest element of the sequence fitting into the remainder. For example, 36=28+6+2=A₁₀⁽³⁾+A₆⁽³⁾+A₂⁽³⁾, so its representation according to A⁽³⁾ would be 100010010. As a result of the encoding procedure, the indices i₁,i₂, . . . of the elements in the sum x=Σᵢ₌₂^{r}cᵢAᵢ^{(m)} for which cᵢ=1 satisfy that iₖ₊₁≧iₖ+m, for k>2. In the above example x=36 these indices are 3, 6 and 10. This implies that in the corresponding binary representation, there are at least, m−1 zeros between any two 1s.

TABLE 1
Generalization of Fibonacci based numeration systems

| m | φₘ | aₘ | In_{φm} 2 | A₂^{(m)}, A₃^{(m)}, A₄^{(m)}, . . . |
|---|---|---|---|---|
| 2 | 1.6180 | 0.8541 | 1.4404 | 1 2 3 5 8 13 21 55 89 144 233 377 610 987 1597 2584 |
| 3 | 1.4656 | 0.7614 | 1.8133 | 1 2 3 4 6 9 13 19 28 41 60 88 129 189 277 406 595 872 |
| 4 | 1.3803 | 0.6946 | 2.1507 | 1 2 3 4 5 7 10 14 19 26 36 50 69 95 131 181 250 345 476 |
| 5 | 1.3247 | 0.6430 | 2.4650 | 1 2 3 4 5 6 8 11 15 20 26 34 45 60 80 106 140 185 245 |
| 6 | 1.2852 | 0.6016 | 2.7625 | 1 2 3 4 5 6 7 9 12 16 21 27 34 43 55 71 92 119 153 196 |
| 7 | 1.2554 | 0.5672 | 3.0472 | 1 2 3 4 5 6 7 8 10 13 17 22 29 35 43 53 66 83 105 133 |
| 8 | 1.2321 | 0.5380 | 3.3215 | 1 2 3 4 5 6 7 8 9 11 14 18 23 29 36 44 53 64 78 96 119 |

Using tire same argument as above for the Fibonacci numbers, the length r−1 of the representation according to A^{(m)} of an integer smaller than 2ⁿ will be about (log_{φm}2) n. These numbers represent the storage penalty paid for the passage to A^{(m)} and are listed in the 4th column of Table 1.

The encoding procedure is similar to the three step procedure described earlier.

In the first step, the n bits of the block are transformed into a block of size r=(log_{φm}2) n by recoding the integer represented in the input block into its representation according to A^{(m)}. The resulting block will be longer, since more bits are needed, but also the larger m, the sparser will the representation be, because of the property forcing at least m−1 zeros between any two 1s.

In the second step, as above, a maximal number 1-bits is added without, violating the property of having at least m−1 zeros after each 1. This means that in a run of zeros of length j, limited on both sides by 1s, with j≧2m−1, the zeros in positions m, 2m, . . . ,

$$⌊ \frac{j - m + 1}{m} ⌋ m$$

are turned on. For a run of leading zeros or length j (limited by a 1-bit only at its right end), for j≧m, the zeros in positions 1, m+1, 2m+1, . . . ,

$$⌊ \frac{j - m}{m} ⌋ m + 1$$

are turned on. For example, for A⁽³⁾, 100000000001 is turned into 100100100001, and 0000001 is turned into 0010001. As a result of this filling strategy, the data block still does have at least m−1 zeros between 1s, but the lengths of the 1-limited zero-runs are now between m−1 and 2m−1, and the length of the leading run is between 0 and m−1.

In the third step, new data is encoded in the m−1 bits immediately to the right of every 1-bit. Since it is known that these positions contained only zeros at the end of step 2, they can be used at this stage to record new data, and their location can be identified. To continue the analogy with the case m=2, there are now data bits of different kinds D₁ to Dₘ₋₁, and similarly for extension bits E₁ to Eₘ₋₁.

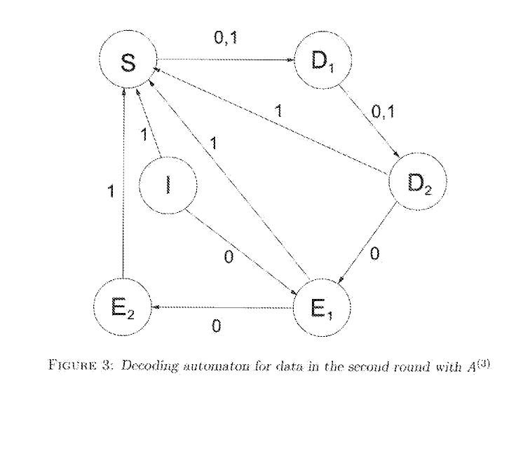

The decoding of the data of the second round at the end of the third step for A⁽³⁾ can be done using the decoding automaton appearing in FIG. 3. An initial state 1 is used to decide whether to start in state S if the first bit is a 1, or in state E₁ if it is a zero. Only bits leading to states D₁ or D₂ are considered to carry information. There is no edge labeled 0 emanating from state E₂, because a second E-bit is always followed by 1s. Similar decoding automata, with states I, S, D₁ to Dₘ₋₁ and E₁ to Eₘ₋₁ can be designed for all m≧2.

Since at the end of the second step, no run of zeros can be longer than 2m−2, the worst case scenario is when every (2m−1)th bit is a separator. Any block is then of the form SDD . . . DEE . . . ESDD . . . DEE . . . , where all the runs of Ds and Es are of length m−1 and (m−1)/(2m−1) of the bits are data-bits. The worst, case compression factor is thus

$$\frac{( m - 1 ) ( {log}_{{ϕ}_{m}} 2 ) n}{\frac{2 m - 1}{( {log}_{{ϕ}_{m}} 2 ) n}} = \frac{m - 1}{2 m - 1} + \frac{1}{{log}_{{ϕ}_{m}} 2} . \qquad ( 1 )$$

The maximal possible benefit will be in the case when there are no E-bits at all, that is, the block is of the form SDD . . . DSDD . . . DSD . . . , where all the runs of Ds are of length m−1 and the number of data-bits is (m−1)/m. In this case, the compression ratio will be

$$\frac{m - 1}{m} + \frac{1}{{log}_{{ϕ}_{m}} 2} . \qquad ( 2 )$$

TABLE 2
Compression ratios with A^{(m)}

| | prob | Best case | | Worst case | | Average case | | with RS-code | |
|---|---|---|---|---|---|---|---|---|---|
| m | of 1-bit | ratio | compr | ratio | compr | ratio | compr | compr | imprv |
| 2 | 0.2763 | 1/2 | 1.194 | 1/3 | 1.028 | 1/2.138 | 1.162 | 1.318 | −1.1% |
| 3 | 0.1945 | 2/3 | 1.218 | 2/5 | 0.952 | 2/3.154 | 1.186 | 1.397 | 4.8% |
| 4 | 0.1511 | 3/4 | 1.215 | 3/7 | 0.894 | 3/4.137 | 1.190 | 1.432 | 7.4% |
| 5 | 0.1240 | 4/5 | 1.206 | 4/9 | 0.850 | 4/5.114 | 1.188 | 1.449 | 8.7% |
| 6 | 0.1055 | 5/6 | 1.195 | 5/11 | 0.817 | 5/6.094 | 1.182 | 1.456 | 9.2% |
| 7 | 0.0919 | 6/7 | 1.185 | 6/13 | 0.790 | 6/7.078 | 1.176 | 1.4584 | 9.38% |
| 8 | 0.0814 | 7/8 | 1.176 | 7/15 | 0.768 | 7/8.067 | 1.169 | 1.4580 | 9.36% |

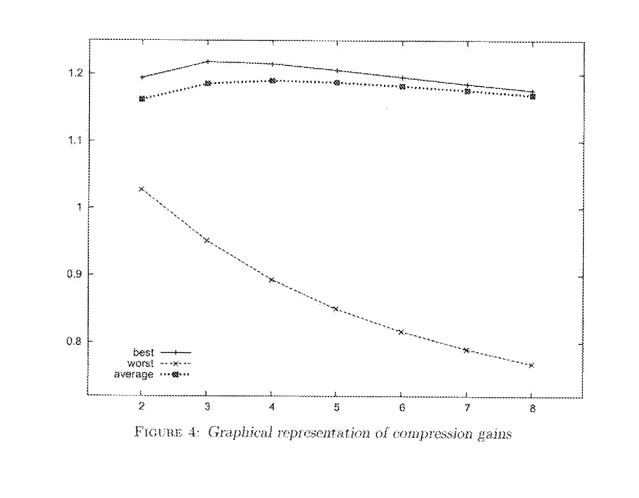

As to the average compression ratio, we omit here the details but list, all the results, the best, worst, and average compression ratios for 2≦m≦6, in Table 2. For each case, the columns headed ratio show the proportion of data-bits relative to the total number of bits used in the second round. The denominator in the ratio column for the average case is the expected distance between 1-bits E^{(m)}. As can be seen, for the average case there is always a gain relative to the baseline, and in the worst case only for m=2. FIG. 4 plots these values, showing that the average case is much closer to the best case than to the worst. The best values for each case are emphasized. Interestingly, while m=2 is best in the worst case, the highest value in the best case is obtained for m=3, and the best average is achieved with m=4.

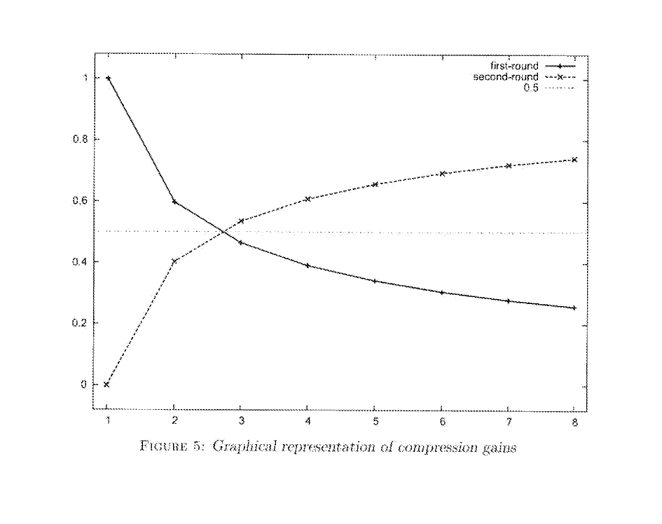

It should be noted that the present invention is relevant only for applications in which the data to be encoded can be partitioned into several writing round, and under the assumption that in any round, the data of the previous rounds is not accessible any more. If these assumptions do not apply, the second and subsequent rounds can be skipped, which corresponds to extending the definition of the sequence A^{(m)} also to m=1. Indeed, for m−1, one gets the sequence of powers of 2, that is, the standard binary numeration system, with no restrictions on the appearance of 1-bits. The compression ratio in that case will be 1. For higher values of m, the combined compression ratio will be higher, but the proportion of the first round data will be smaller. Table 3 brings; these proportions for 1≦m≦8, and FIG. 5 displays them graphically.

TABLE 3
Proportions of first and second round data bits

| m | 1 | 2 | 3 | 4 | 5 | 6 | 7 | 8 |
|---|---|---|---|---|---|---|---|---|
| first round | 1.000 | 0.597 | 0.465 | 0.391 | 0.342 | 0.306 | 0.279 | 0.258 |
| second round | 0.000 | 0.403 | 0.535 | 0.609 | 0.658 | 0.694 | 0.721 | 0.742 |

One way to look at these results is thus to choose the order m of the encoding according to the partition between first and second round data one may be interested in.

### 5.4 Usage as Compression Booster

The above ideas can be used to build a compression booster in the following way. Suppose we are given a rewriting system S allowing k rounds. This can be turned into a system with k+1 rounds by using, in a first round, the new encoding as described earlier, which identifies a subset of the bits in which the new data can be recorded. These bits are then used in k additional rounds according to S. Note that only context-insensitive systems, like the RS-code, can be extended in that way. Since the first round recodes the data using more bits, the extension with an additional round of rewriting will not always improve the compression. For example, for the Fibonacci code, even if the first term of the numerator of equation (1), representing the number of bits used in the second round, is multiplied by

$$\frac{4}{3} ,$$

the compression factor of the RS-code, one still gets only 1.318, about 1.1% less than the RS-code used alone. However, using A^{(m)} codes with m>2 in the first round, followed by two rounds of RS, may yield better codes than RS as can be seen in the last two columns of Table 2, giving the compression ratios and the relative improvement over RS.

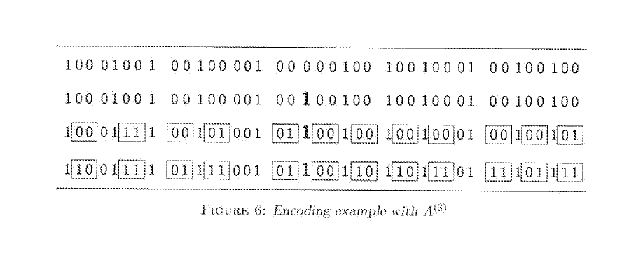

FIG. 6 brings the same running example as above, this time A⁽³⁾, and coupled with the RS-code. The same input character string NQx is used, and the 24-bit numerical value 5,132,664 of its ASCII encoding (with leading zeros), is given in A⁽³⁾ encoded form with 40 bits in the first line. The second line displays the block at the end of step 2, after having added, for this particular example, a single 1-bit which is bold-faced. The data bits that can be used in the next, step are the pairs immediately to the right of the 1-bits and are currently all zero. In this example, there are 24 such bits. For the next, step, suppose the new data to be stored in the second round is the number 55,555, and in the third round the number 44,444, whose standard 16-bit binary representation are 11 01 10 01 00 00 00 11 and 10 10 11 01 10 01 11 00, respectively. The RS-code considers these numbers as a sequence of pairs (the spaces have only been added for clarity), each of which is translated into a triplet, yielding two 24-bit strings 001 100 010 100 000 000 000 001 and 101 101 110 100 101 011 110 111. These bits are interspersed into the data bits of the block, resulting in the string appearing in the third and fourth lines, in which these data bits are boxed in pairs. In this example, the combined number of information bits is 24 for the string NQx, plus 16 for each of the numbers 55,555 and 44,444, that is 56 bits, but using only 40 bits of storage, yielding a compression ratio of 1.4. Using the RS-code alone with 40 bits would only be able to store 53.3 bits of information, Note also that as before, all the changes from one step to another are consistent with the flash memory constraints, namely that only changes from 0 to 0.1 are allowed, but not from 1 to 0.

1. A method for encoding data a plurality of times on a storage device for which a 0-bit can be turned into a 1-bit but a 1-bit cannot be turned into a 0-bit, the method being based on encoding data in a first round in such a way that certain bit positions can be identified in subsequent rounds as carrying new data, and such that the expected overall amount of data written in ail the writing rounds together is larger than the available number of bits.

2. The method of claim 1 wherein the number of times data is written on the storage device is two.

3. The method of claim 2 wherein said bit positions can be identified because said encoding method used in the first round avoids certain bit-patterns.

4. The method of claim 3 wherein the encoding method used in the first round is representing integers as a sum of non-consecutive Fibonacci numbers, implying that in the corresponding binary encoding there is no occurrence of the bit-pattern 11.

5. Tire method of claim 4 wherein the bit positions following immediately the 1-bits written in the first round can be used to store new data in the second round.

6. The method of claim 5 wherein the number of bit positions used in the second round can be increased by adding, after the first round of writing, more 1-bit s without violating the rule of having no adjacent 1-bits.

7. The method of claim 3 wherein the encoding method used in the first round is choosing an integer parameter m with m≧2, and representing integers as a sum of generalized Fibonacci numbers Aₖ^{(m)}, defined by
Aₖ^{(m)}=Aₖ₋₁^{(m)}+Aₖ₋ₘ^{(m)} for k>m+1,
and the boundary conditions
Aₖ^{(m)}=k−1for 1<k≦m+1,
implying that in the corresponding binary encoding there are at least m−1 zeros between any two 1-bits.

8. The method of claim 7 wherein the m−1 bit positions following immediately the 1-bits written in the first round can be used, to si ore new data in the second round.

9. The method of claim 8 wherein the number of bit positions used in the second round can be increased by adding, after the first round of writing, more 1-bits without violating the rule of having at least, m−1 zeros between any two 1-bits.

10. The method of claim 1 wherein said method is used as a compression booster, turning any given context insensitive rewriting code with k writing rounds, for k≧1, into a rewriting code with, k+1 writing rounds.
